(19) United States
(12) Patent Application Publication
(10) Pub. No.: US 2021/0021123 A1
(43) Pub. Date: Jan. 21, 2021

(54) ELECTROSTATIC DISCHARGE PROTECTION CIRCUIT FOR RADIO FREQUENCY CIRCUIT, ELECTROSTATIC DISCHARGE PROTECTION METHOD AND ASSOCIATED RADIO FREQUENCY CIRCUIT THEREOF

(71) Applicant: Realtek Semiconductor Corp., HsinChu (TW)

(72) Inventors: Kuan-Yu Shih, New Taipei City (TW); Ka-Un Chan, Hsinchu County (TW)

(21) Appl. No.: 16/792,283

(22) Filed: Feb. 16, 2020

(30) Foreign Application Priority Data
Jul. 17, 2019 (TW) 108125192

(51) Int. Cl. H02H 9/04

(52) U.S. Cl. CPC H02H 9/046; H04B 1/40

(57) ABSTRACT

An electrostatic discharge (ESD) protection circuit for a radio frequency (RF) circuit, an ESD protection method and an associated RF circuit are provided. The ESD protection circuit includes a set of ESD components coupled between a positive receiving terminal and a negative receiving terminal of a receiver within the RF circuit, wherein the positive receiving terminal and the negative receiving terminal are respectively configured to receive a positive terminal signal and a negative terminal signal, and the positive terminal signal and the negative terminal signal are a pair of differential signals. In operations of the ESD protection circuit, the set of ESD components may be conductive in response to a voltage difference between a voltage level of the positive terminal signal and a voltage level of the negative terminal signal being greater than a predetermined difference value.

### BACKGROUND OF THE INVENTION

### 1. Field of the Invention

The present invention is related to electrostatic discharge (ESD) protection, and more particularly, to an ESD protection circuit for a radio frequency (RF) circuit, an ESD protection method and an associated RF circuit thereof.

### 2. Description of the Prior Art

During a process of manufacturing integrated circuits, equipment that has electrostatic charges accumulated thereon may directly contact the chips. Without protection against electrostatic discharge (ESD), these accumulated electrostatic charges will enter core circuit (s) within a chip at the moment of contact, thereby causing permanent damage to the core circuit(s). To prevent this, ESD protection components may be installed on input/output (I/O) pin(s) of the chip. In some related arts, the I/O pin(s) and the circuit to be protected may be connected via a resistor, so the electrostatic charges will not flow towards a path leading to the circuit when the electrostatic charges enter the chip, since impedance (e.g. resistance) of this path is greater than others. This method cannot guarantee where these electrostatic charges will flow, however. Thus, other related arts may install an ESD path on the I/O pins so these electrostatic charges can be discharged.

In some specific fields, a protection capability of the aforementioned ESD protection mechanism may be insufficient. For example, in a radio frequency (RF) chip, electrostatic signals of some specific frequencies can enter circuits of the RF chip particularly easily. Thus, there is a need for a novel ESD protection mechanism which can enhance the ESD protection capability of the RF chip without introducing any side effect or in a way that is less likely to introduce side effects.

### SUMMARY OF THE INVENTION

An objective of the present invention is to provide an electrostatic discharge (ESD) protection circuit for a radio frequency (RF) circuit, an ESD protection method and an associated RF circuit thereof, in order to enhance ESD protection capability of a RF chip without introducing any side effect or in a way that is less likely to introduce side effects.

At least one embodiment of the present invention provides an ESD protection circuit for an RF circuit. The ESD protection circuit may comprise a set of ESD components coupled between a positive receiving terminal and a negative receiving terminal of a receiver within the RF circuit, wherein the positive receiving terminal and the negative receiving terminal are respectively configured to receive a positive terminal signal and a negative terminal signal, and the positive terminal signal and the negative terminal signal are a pair of differential signals. In operations of the ESD protection circuit, the set of ESD components may be conductive in response to a voltage difference between a voltage level of the positive terminal signal and a voltage level of the negative terminal signal being greater than a predetermined difference value.

At least one embodiment of the present invention provides an ESD protection method for an RF circuit. The ESD protection method comprises: receiving a positive terminal signal and a negative terminal signal through a positive receiving terminal and a negative receiving terminal of a receiver within the RF circuit, wherein the positive terminal signal and the negative terminal signal are a pair of differential signals; and utilizing a set of ESD components coupled between the positive receiving terminal and the negative receiving terminal to be conductive in response to a voltage difference between a voltage level of the positive terminal signal and a voltage level of the negative terminal signal being greater than a predetermined difference value.

At least one embodiment of the present invention provides an RF circuit. The RF circuit may comprise a receiver and an ESD protection circuit, wherein the receiver has a positive receiving terminal and a negative receiving terminal, and the ESD protection circuit may be coupled to the positive receiving terminal and the negative receiving terminal of the receiver. In addition, the positive receiving terminal and the negative receiving terminal may be respectively configured to receive a positive terminal signal and a negative terminal signal, and the positive terminal signal and the negative terminal signal are a pair of differential signals. More particularly, the ESD protection circuit may comprise a set of ESD components coupled between the positive receiving terminal and the negative receiving terminal, and the set of ESD components may be conductive in response to a voltage difference between a voltage level of the positive terminal signal and a voltage level of the negative terminal signal being greater than a predetermined difference value, in order to prevent the receiver from being damaged by ESD.

The present invention provides an ESD protection circuit and an ESD protection method regarding differential receiving terminals that receive differential signals, and enhances the ESD protection capability of the RF chip. In addition, in comparison with the related art, embodiments of the present invention will not greatly increase costs. Thus, the present invention can solve the problems of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a radio frequency (RF) circuit according to an embodiment of the present invention.

FIG. 2 is a diagram illustrating an RF circuit according to another embodiment of the present invention.

FIG. 3 is a diagram illustrating an RF circuit according to an embodiment of the present invention.

FIG. 4 is a diagram illustrating an RF circuit according to an embodiment of the present invention.

FIG. 5 is a diagram illustrating an RF circuit according to an embodiment of the present invention.

FIG. 6 is a diagram illustrating an RF circuit according to an embodiment of the present invention.

FIG. 7 is a flowchart illustrating an electrostatic discharge (ESD) method according to an embodiment of the present invention.

### DETAILED DESCRIPTION

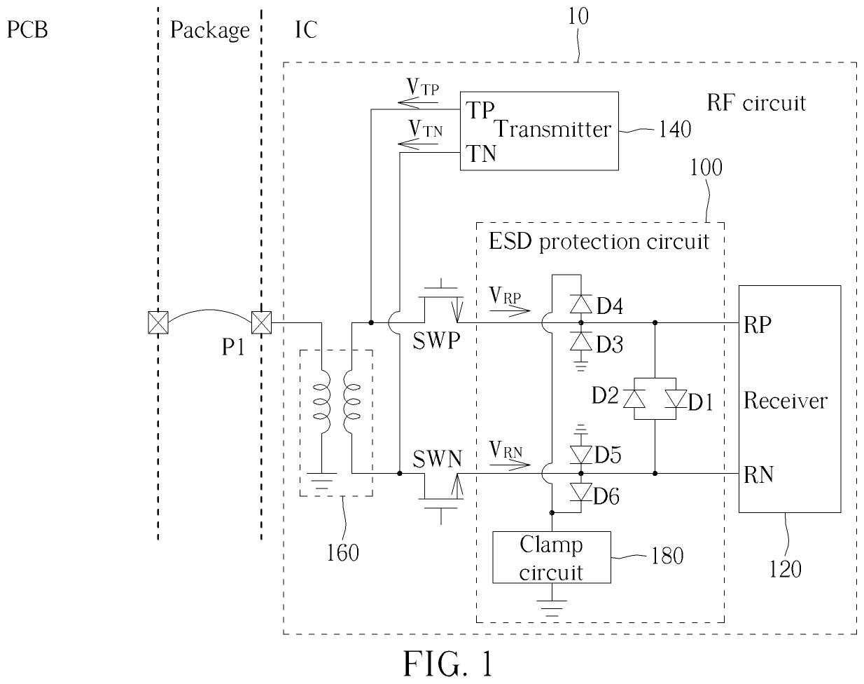

FIG. 1 is a diagram illustrating a radio frequency (RF) circuit 10 according to an embodiment of the present invention. In this embodiment, the RF circuit 10 may be implemented in an integrated circuit (IC), where the RF circuit 10 comprises a receiver 120, a transmitter 140 and a conversion circuit 160. It should be noted that the receiver 120 and the transmitter 140 use shared pins for being connected to components outside the IC (e.g. a package, a printed circuit board (PCB), an antenna, etc.) in this embodiment. As shown in FIG. 1, the receiver 120 may have a positive receiving terminal such as a receiving terminal RP and a negative receiving terminal such as a receiving terminal RN, where the receiving terminals RP and RN may be coupled to the conversion circuit 160 via switches SWP and SWN, respectively. In addition, the transmitter 140 may have a positive transmitting terminal such as a transmitting terminal TP and a negative transmitting terminal such as a transmitting terminal TN, where the transmitting terminals TP and TN may be coupled to the conversion circuit 160.

In a first operation mode (e.g. a transmitting mode) of the RF circuit 10, the switches SWP and SWN are turned off. The transmitter 140 may transmit a pair of differential signals such as signals {V_{TP}, V_{TN}} to the conversion circuit 160 (e.g. transmit signals V_{TP} and V_{TN} via the transmitting terminals TP and TN, respectively), and the conversion circuit 160 may convert the signals {V_{TP}, V_{TN}} into a single-ended output signal and transmit the single-ended output signal to outside the IC via a pin P1. In a second operation mode (e.g. a receiving mode) of the RF circuit 10, the switches SWP and SWN are turned on, where the conversion circuit 160 may receive a single-ended input signal from outside the IC via the pin P1, and the conversion circuit 160 may convert the single-ended input signal into a pair of differential signals such as signals {V_{RP}, V_{RN}} to the receiver 120 (e.g. the receiver 120 receives the signals V_{RP} and V_{RN} via the receiving terminals RP and RN, respectively). Typically, the signals {V_{TP}, V_{TN}} and the signals {V_{RP}, V_{RN}} will not appear at the same time. For better comprehension, the signals {V_{TP}, V_{TN}} and the signals {V_{RP}, V_{RN}} may be depicted in FIG. 1 together, but the present invention is not limited thereto. In this embodiment, the conversion circuit 160 may be implemented by a balanced to unbalanced (Balun) converter as shown in FIG. 1, but the present invention is not limited thereto.

In this embodiment, as a voltage dynamic range of the pair of differential output signals transmitted by the transmitter 140 is great enough (e.g. +7 V to −7 V), the transmitter 140 has certain tolerance against electrostatic discharge (ESD); and as a dynamic range of the pair of differential input signals received by the receiver 120 is small (e.g. e.g. +1 V to the receiver 120 needs to rely on an additional ESD protection circuit to enhance the tolerance against ESD. In addition, as the voltage dynamic ranges of the pair of differential output signals and the pair of differential input signals are different, the associated ESD protection circuit cannot be installed at the location of the pin P1. Instead, the ESD protection circuit should be installed on the input terminals (e.g. the receiving terminals RP and RN) of the receiver 120. In this embodiment, the RF circuit 10 may further comprise an ESD protection circuit 100, where the ESD protection circuit 100 may comprise a set of ESD components coupled between the receiving terminals RP and RN, and the set of ESD components may be conductive in response to a voltage difference between a voltage level of the signal V_{RP} and a voltage level of the signal V_{RN} being greater than a predetermined difference value. More specifically, the set of ESD components may comprise a first ESD component (such as a diode D1) and a second ESD component (such as a diode D2), where an anode and a cathode of the diode D1 are respectively coupled to the receiving terminals RP and RN, and an anode and a cathode of the diode D2 are respectively coupled to the receiving terminals RN and RP. For example, the diode D1 may be conductive in response to the voltage level of the signal V_{R}p being greater than the voltage level of the signal V_{RN} and a voltage difference between the voltage level of the signal V_{R}p and the voltage level of the signal V_{RN} (e.g. an absolute value of a difference between these two voltage levels) being greater than a predetermined difference value (e.g. a forward bias voltage applied to the diode D1 is greater than a threshold voltage of the diode D1); in another example, the diode D2 may be conductive in response to the voltage level of the signal V_{R}p being less than the voltage level of the signal V_{RN} and the voltage difference between the voltage level of the signal V_{RP} and the voltage level of the signal V_{RN} being greater than the predetermined difference value (e.g. a forward bias voltage applied to the diode D2 is greater than a threshold voltage of the diode D2). Thus, when the RF circuit 10 operates in the receiving mode (e.g. the switches SWP and SWN are turned on), if an ESD event occurs on the pin P1 or any device connected to the pin P1, resulting in these electrostatic charges being converted into a pair of differential ESD signals by the conversion circuit 160, the diode D1 or D2 may be conductive in response to the pair of differential ESD signals to prevent the receiver 120 from being damaged by the pair of differential ESD signals.

In practice, the conversion circuit 160 might be unable to perfectly perform single-to-differential conversion. For example, differential signals obtained by the conversion might have an offset, which makes a common mode voltage level of the differential signals deviate from a predetermined level. Under the above situation, if an ESD event occurs on the pin P1 or any device connected to the pin P1, resulting in these electrostatic charges being converted into a pair of differential ESD signals having the offset by the conversion circuit 160, where a voltage difference between the pair of differential ESD signals (e.g. an absolute value of a difference between respective voltage levels of these two signals) might be insufficient to make the diode D1 or D2 conductive, but a voltage level one of the pair of differential ESD signals might have already exceeded a predetermined range (e.g. an allowable voltage range of a single terminal or node), the risk of the receiver 120 being damaged due to ESD will still exist. Thus, the ESD protection circuit 100 may further comprise a set of positive terminal discharge components and a set of negative terminal discharge components, where the set of positive terminal discharge components may be coupled between the receiving terminal RP and at least one reference terminal (e.g. a ground voltage terminal and/or a power voltage terminal), and the set of negative terminal discharge components may be coupled between the receiving terminal RN and the aforementioned at least one reference terminal (e.g. the ground voltage terminal and/or the power voltage terminal). In this embodiment, the set of positive terminal discharge components may be conductive in response to the voltage level of the signal V_{RP} exceeding the predetermined range, and the set of negative terminal discharge components may be conductive in response to the voltage level of the signal V_{RN} exceeding the predetermined range. In addition, the ESD protection circuit 100 may further comprise a clamp circuit 180 to limit a voltage difference between a voltage level of a first reference terminal (e.g. the power voltage terminal) and a voltage level of a second reference terminal (e.g. the ground voltage terminal) within the aforementioned at least one reference terminal, e.g. an absolute value of a difference between these two voltage levels, where the clamp circuit 180 is not limited to a specific architecture. Any implementation of a circuit (e.g. the clamp circuit) that can be conductive in response to the voltage difference between the voltage level of the power voltage terminal and the voltage level of the ground voltage terminal reaching a predetermined threshold value, to make the voltage difference between the voltage level of the power voltage terminal and the voltage level of the ground voltage terminal remain in the predetermined threshold value, is applicable to the present invention.

As shown in FIG. 1, the set of positive terminal discharge components may comprise diodes D3 and D4, where an anode and a cathode of the diode D3 are respectively coupled to the ground voltage terminal and the receiving terminal RP, and an anode and a cathode of the diode D4 are respectively coupled to the receiving terminal RP and the power voltage terminal (e.g. an upper terminal of the clamp circuit 180). In addition, the set of negative terminal discharge components may comprise diodes D5 and D6, where an anode and a cathode of the diode D5 are respectively coupled to the ground voltage terminal and the receiving terminal RN, and an anode and a cathode of the diode D6 are respectively coupled to the receiving terminal RN and the power voltage terminal. When the voltage level of the signal V_{RP} exceeds the predetermined range due to ESD, the diode D3 or D4 may be conductive to make an electrostatic current flow toward the ground voltage terminal or the power voltage terminal (e.g. flow toward the clamp circuit 180). For example, when the voltage level of the signal V_{RP} becomes higher than an allowable maximum level of the receiving terminal RP due to ESD (e.g. positive charges), the diode D4 may be conductive to make these positive charges flow toward the power voltage terminal, where since the voltage level of the power voltage terminal is pulled up due to these positive charges, the clamp circuit 180 may be conductive to make these positive charges flow toward the ground voltage terminal. In another example, when the voltage level of the signal V_{RP} becomes lower than an allowable minimum level of the receiving terminal RP due to ESD (e.g. negative charges), the diode D3 may be conductive to make these negative charges flow toward the ground voltage terminal. When the voltage level of the signal V_{RN} exceeds the predetermined range due to ESD, the diode D5 or D6 may be conductive to make an electrostatic current flow toward the ground voltage terminal or the power voltage terminal (e.g. flow toward the clamp circuit 180). For example, when the voltage level of the signal V_{RN} becomes higher than an allowable maximum level of the receiving terminal RN due to ESD (e.g. positive charges), the diode D6 may be conductive to make these positive charges flow toward the power voltage terminal, where since the voltage level of the power voltage terminal is pulled up due to these positive charges, the clamp circuit 180 may be conductive to make these positive charges flow toward the ground voltage terminal; in another example, when the voltage level of the signal V_{RN} becomes lower than an allowable minimum level of the receiving terminal RN due to ESD (e.g. negative charges), the diode D5 may be conductive to make these negative charges flow toward the ground voltage terminal.

As mentioned above, the ESD protection circuit 100 of the present invention utilizes the diodes D3 and D4 and the clamp circuit 180 to guarantee circuits connected with the receiving terminal RP will not be damaged due to ESD; utilizes the diodes D5 and D6 and the clamp circuit 180 to guarantee circuits connected with the receiving terminal RN will not be damaged due to ESD; and utilize the diodes D1 and D2 to provide a more efficient ESD path regarding the differential signals received by the receiving terminals RP and RN.

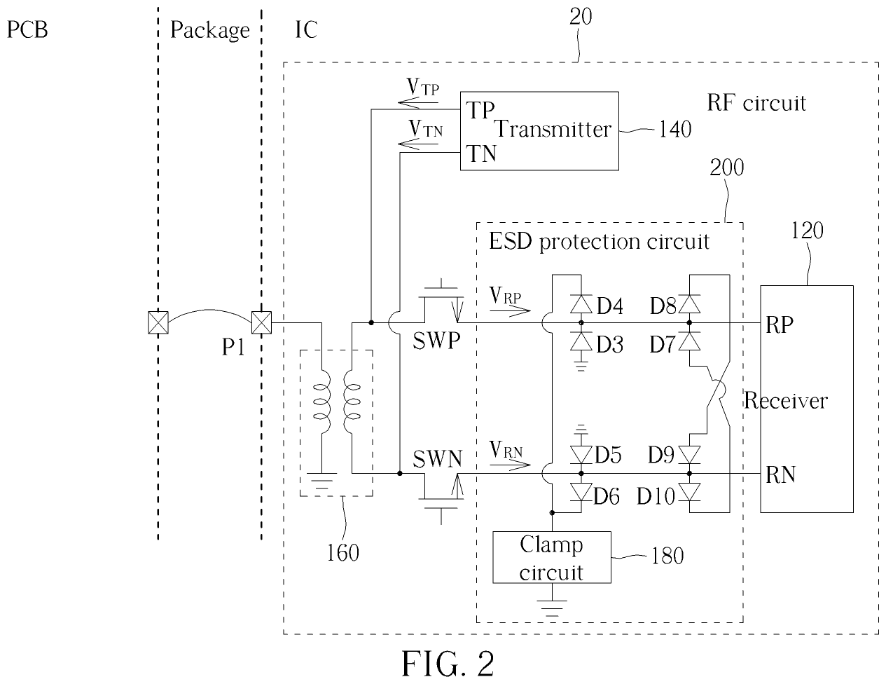

In addition, each of the first ESD component and the second ESD component is not limited to be implemented by a single diode. More particularly, a number of diode(s) within each of the first ESD component and the second ESD component may be determined in response to the voltage dynamic range of the differential signals received by the receiver 120. Assuming that the threshold voltages of all diodes in embodiments of the present invention are 0.7V, the ESD protection circuit 100 shown in FIG. 1 may allow the receiver 120 to receive the differential signals having a voltage dynamic range from +0.7 V to −0.7 V (e.g. each of the receiving terminals RP and RN needs to receive a signal having a voltage dynamic range from +0.35 V to −0.35 V). In another embodiment, if the receiver 120 needs to receive differential signals having a dynamic range from +1.4 V to −1.4 V (e.g. each of the receiving terminals RP and RN needs to receive a signal having a voltage dynamic range from +0.7 V to −0.7 V), the number of diodes within each of the first ESD component and the second ESD component may be modified to be two, as shown in an ESD protection circuit 200 within an RF circuit 20 in FIG. 2. As each of the first ESD component and the second ESD component within the ESD protection circuit 200 coupled between the receiving terminals RP and RN comprises multiple diodes connected in series (e.g. the first ESD component within the ESD protection circuit 200 may comprise diodes D8 and D9 connected in series, and the second ESD component within the ESD protection circuit 200 may comprise diodes D10 and D7 connected in series), the first ESD component (e.g. the diodes D8 and D9) within the ESD protection circuit 200 may be conductive in response to the voltage level of the signal V_{R}p being greater than the voltage level of the signal V_{RN} and the voltage difference between the voltage level of the signal V_{R}p and the voltage level of the signal V_{RN} being greater than 1.4 V (e.g. 0.7 V×2), and the second ESD component (e.g. the diodes D10 and D7) within the ESD protection circuit 200 may be conductive in response to the voltage level of the signal V_{RP} being less than the voltage level of the signal V_{RN} and the voltage difference between the voltage level of the signal V_{RP} and the voltage level of the signal V_{RN} being greater than 1.4 V (e.g. 0.7 V×2). As a result, the ESD protection circuit 200 may allow the receiver 120 to receive the differential signals having a voltage dynamic range from +1.4 V to −1.4 V. Deduced by analogy, the number of diodes within each of the first ESD component and the second ESD component within the ESD protection circuit 200 may be modified as a number more than two in response to the requirement of the voltage dynamic range of the differential signals received by the receiver 120, but the present invention is not limited thereto.

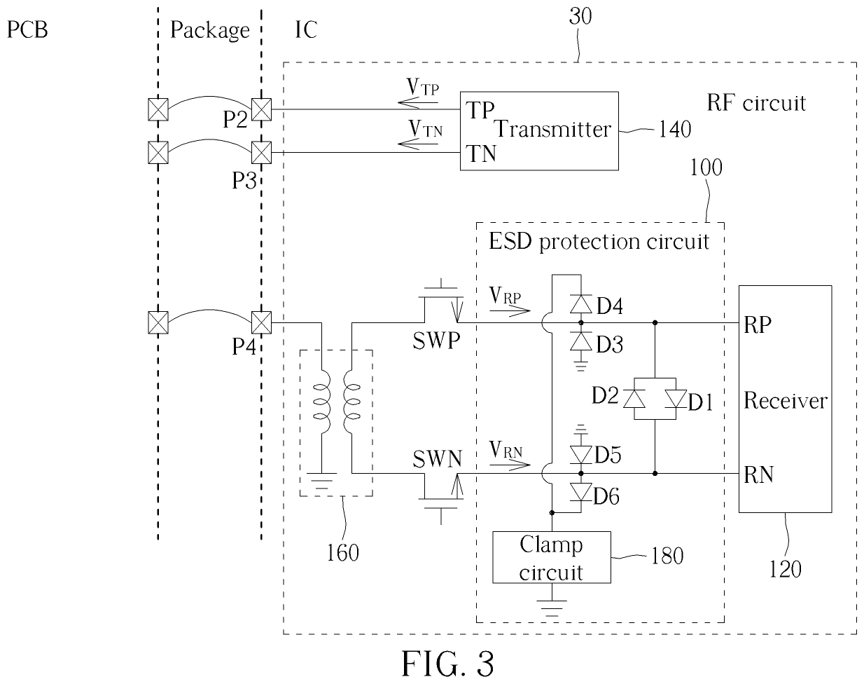

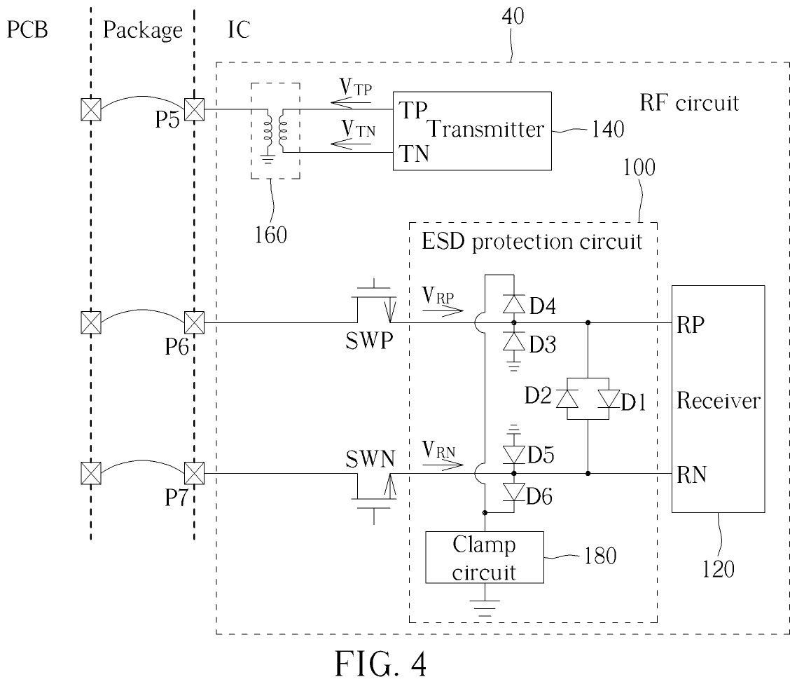

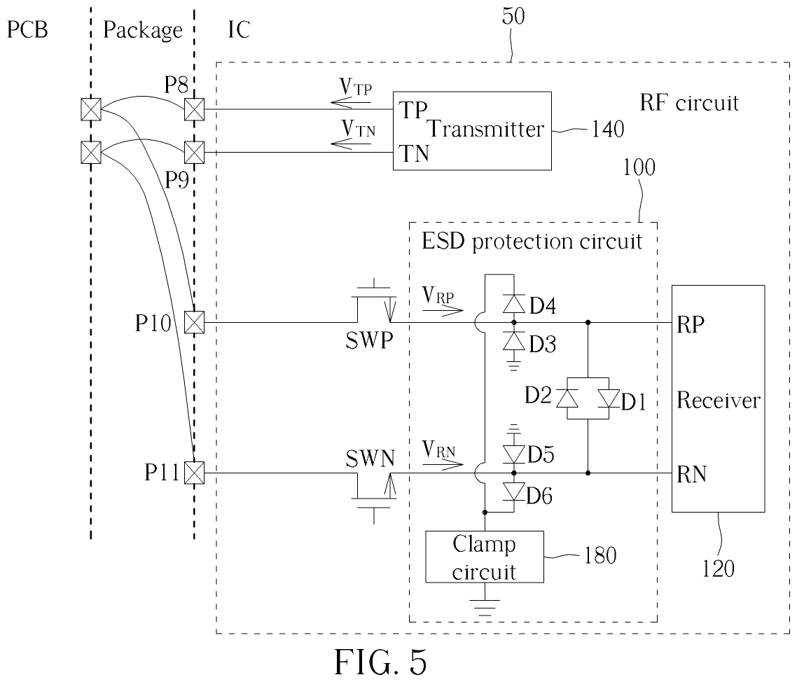

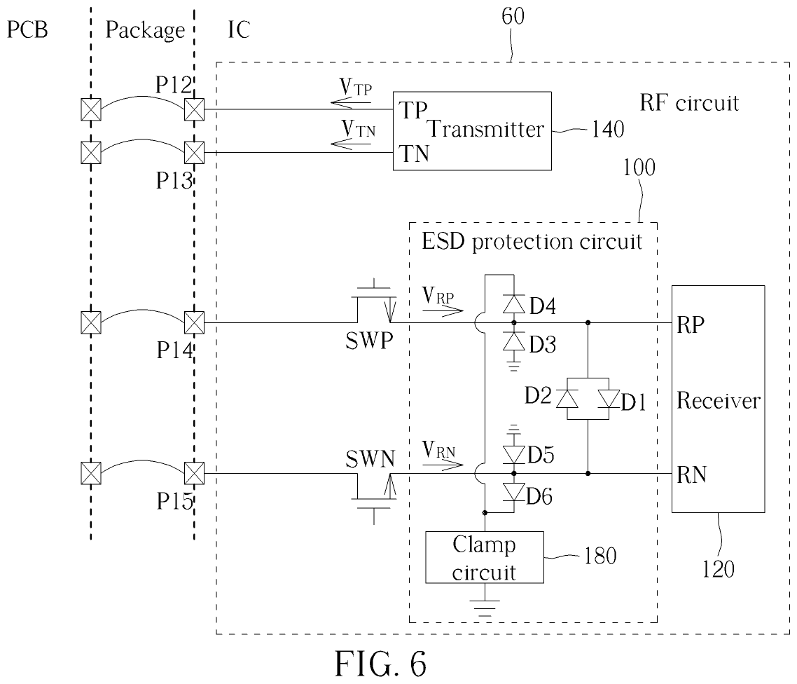

In the embodiments of FIG. 1 and FIG. 2, the transmitter 140 and the receiver 120 utilize the shared pin P1 to perform signal transmission with the outside of the IC, but the present invention is not limited thereto. In embodiments shown in FIG. 3 to FIG. 6, each of the transmitter 140 and the receiver 120 has its own dedicated pin to perform signal transmission with the outside of the IC. In the embodiment shown in FIG. 3, the transmitter 140 within an RF circuit 30 may utilize pins P2 and P3 to respectively transmit a pair of differential output signals such as the signals {V_{TP}, V_{TN}} to the outside of the IC; the receiver 120 within the RF circuit 30 may utilize a pin P4 to receive a single-ended input signal from the outside of the IC, and then utilize the conversion circuit 160 to convert the single-ended input signal into a pair of differential input signals such as the signals {V_{RP}, V_{RN}}, where the pins P2, P3 and P4 may be respectively connected to respective dedicated pins on the PCB. In the embodiment shown in FIG. 4, the transmitter 140 within an RF circuit 40 may utilize the conversion circuit 160 to convert a pair of differential output signals such as the signals {V_{TP}, V_{TN}} into a single-ended output signal, and then utilize a pin P5 to transmit the single-ended output signal to the outside of the IC; the receiver 120 within the RF circuit 40 may utilize pins P6 and P7 to respectively receive a pair of differential input signals such as the signals {V_{RP}, V_{RN}} from outside of the IC, where the pins P5, P6 and P7 may be respectively connected to respective dedicated pins on the PCB. In the embodiment shown in FIG. 5, the transmitter 140 within an RF circuit 50 may utilize pins P8 and P9 to respectively transmit a pair of differential output signals such as the signals {V_{T}p, V_{TN}} to the outside of the IC, and the receiver 120 within the RF circuit 50 may utilize pins P10 and P11 to respectively receive a pair of differential input signals such as the signals {V_{RP}, V_{RN}} from outside of the IC, where the pins P8 and P10 may be connected to a shared pin on the PCB, and the pins P9 and P11 may be connected to another shared pin on the PCB. In the embodiment shown in FIG. 6, the transmitter 140 within an RF circuit 60 may utilize pins P12 and P13 to respectively transmit a pair of differential output signals such as the signals {V_{TP}, V_{TN}} to the outside of the IC, and the receiver 120 within the RF circuit 60 may utilize pins P14 and P15 to respectively receive a pair of differential input signals such as the signals {V_{RP}, V_{RN}} from the outside of the IC, where the pins P12, P13, P14 and P15 may be respectively connected to respective dedicated pins on the PCB. As mentioned above, the transmitter 140 and the receiver 120 are not limited to perform signal transmission with the outside of the IC by single-ended signals, and the pins used by the transmitter 140 and the receiver 120 may be shared or not shared on the IC, the package, or the PCB, wherein the embodiments shown in FIG. 3 to FIG. 6 are for illustrative purposes only, and are not limitations of the present invention.

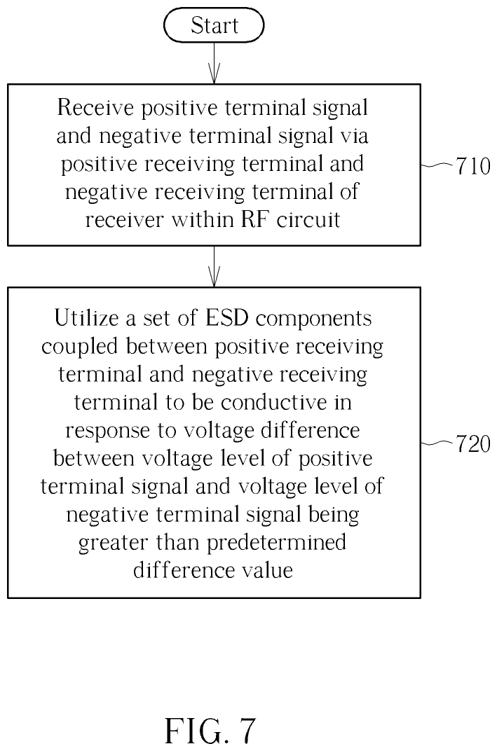

An ESD protection method for an RF circuit (more particularly, ESD protection of a receiver within the RF circuit) of the present invention may be summarized by a flowchart shown in FIG. 7. In Step 710, a positive receiving terminal and a negative receiving terminal of a receiver within the RF circuit may respectively receive a positive terminal signal and a negative terminal signal, where the positive terminal signal and the negative terminal signal are a pair of differential signals. In Step 720, a set of ESD components coupled between the positive receiving terminal and the negative receiving terminal may be conductive in response to a voltage difference between a voltage level of the positive terminal signal and a voltage level of the negative terminal signal being greater than a predetermined difference value.

To summarize, the present invention provides an ESD protection circuit and an ESD protection method, which can efficiently enhance the ESD protection capability of receiving terminals for receiving differential signals. In addition, the present invention can perform ESD protection regarding respective receiving terminals for receiving the differential sign respectively, in order to avoid the risk of ESD damage when the symmetry of differential signals generated by a conversion circuit is not perfect. In addition, the embodiments of the present invention will not greatly increase additional costs. Thus, the present invention can solve the problems of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrostatic discharge (ESD) protection circuit for a radio frequency (RF) circuit, comprising:
a set of ESD components, coupled between a positive receiving terminal and a negative receiving terminal of a receiver within the RF circuit, wherein the positive receiving terminal and the negative receiving terminal are respectively configured to receive a positive terminal signal and a negative terminal signal, and the positive terminal signal and the negative terminal signal are a pair of differential signals;
wherein the set of ESD components is conductive in response to a voltage difference between a voltage level of the positive terminal signal and a voltage level of the negative terminal signal being greater than a predetermined difference value.

2. The ESD protection circuit of claim 1, further comprising:
a set of positive terminal discharge components, coupled between the positive receiving terminal and at least one reference terminal, configured to be conductive in response to the voltage level of the positive terminal signal exceeding a predetermined range; and
a set of negative terminal discharge components, coupled between the negative receiving terminal and said at least one reference terminal, configured to be conductive in response to the voltage level of the negative terminal signal exceeding the predetermined range.

3. The ESD protection circuit of claim 2, wherein said at least one reference terminal comprises a first reference terminal and a second reference terminal, and the ESD protection circuit further comprises a clamp circuit to limit a voltage difference between a voltage level of the first reference terminal and a voltage level of the second reference terminal.

4. The ESD protection circuit of claim 1, wherein the set of ESD components comprise:
a first ESD component, configured to be conductive in response to the voltage level of the positive terminal signal being greater than the voltage level of the negative terminal signal and the voltage difference between the voltage level of the positive terminal signal and the voltage level of the negative terminal signal being greater than the predetermined difference value; and
a second ESD component, configured to be conductive in response to the voltage level of the positive terminal signal being less than the voltage level of the negative terminal signal and the voltage difference between the voltage level of the positive terminal signal and the voltage level of the negative terminal signal being greater than the predetermined difference value.

5. The ESD protection circuit of claim 4, wherein each of the first ESD component and the second ESD component comprises at least one diode.

6. The ESD protection circuit of claim 4, wherein each of the first ESD component and the second ESD component comprises multiple diodes connected in series.

7. An ESD protection method for a radio frequency (RF) circuit, comprising:
receiving a positive terminal signal and a negative terminal signal through a positive receiving terminal and a negative receiving terminal of a receiver within the RF circuit, wherein the positive terminal signal and the negative terminal signal are a pair of differential signals; and
utilizing a set of ESD components coupled between the positive receiving terminal and the negative receiving terminal to be conductive in response to a voltage difference between a voltage level of the positive terminal signal and a voltage level of the negative terminal signal being greater than a predetermined difference value.

8. The ESD protection method of claim 7, further comprising:
utilizing a set of positive terminal discharge components coupled between the positive receiving terminal and at least one reference terminal to be conductive in response to the voltage level of the positive terminal signal exceeding a predetermined range; and
utilizing a set of negative terminal discharge components coupled between the negative receiving terminal and said at least one reference terminal to be conductive in response to the voltage level of the negative terminal signal exceeding the predetermined range.

9. The ESD protection method of claim 8, wherein said at least one reference terminal comprises a first reference terminal and a second reference terminal, and the ESD protection method further comprises:
utilizing a clamp circuit to limit a voltage difference between a voltage level of the first reference terminal and a voltage level of the second reference terminal.

10. The ESD protection method of claim 7, wherein the step of utilizing the set of ESD components to be conductive in response to the voltage difference between the voltage level of the positive terminal signal and the voltage level of the negative terminal signal being greater than the predetermined difference value comprises:
utilizing a first ESD component within the set of ESD components to be conductive in response to the voltage level of the positive terminal signal being greater than the voltage level of the negative terminal signal and the voltage difference between the voltage level of the positive terminal signal and the voltage level of the negative terminal signal being greater than the predetermined difference value; and
utilizing a second ESD component within the set of ESD components to be conductive in response to the voltage level of the positive terminal signal being less than the voltage level of the negative terminal signal and the voltage difference between the voltage level of the positive terminal signal and the voltage level of the negative terminal signal being greater than the predetermined difference value.

11. The ESD protection method of claim 10, wherein each of the first ESD component and the second ESD component comprises at least one diode.

12. The ESD protection method of claim 10, wherein each of the first ESD component and the second ESD component comprises multiple diodes connected in series.

13. A radio frequency (RF) circuit, comprising:
a receiver, having a positive receiving terminal and negative receiving terminal, wherein the positive receiving terminal and the negative receiving terminal are respectively configured to receive a positive terminal signal and a negative terminal signal, and the positive terminal signal and the negative terminal signal are a pair of differential signals; and
an electrostatic discharge (ESD) protection circuit, coupled to the positive receiving terminal and the negative receiving terminal, comprising:
a set of ESD components, coupled between the positive receiving terminal and the negative receiving terminal, configured to be conductive in response to a voltage difference between a voltage level of the positive terminal signal and a voltage level of the negative terminal signal being greater than a predetermined difference value, in order to prevent the receiver from being damaged by ESD.

14. The RF circuit of claim 13, wherein the ESD protection circuit further comprises:
a set of positive terminal discharge components, coupled between the positive receiving terminal and at least one reference terminal, configured to be conductive in response to the voltage level of the positive terminal signal exceeding a predetermined range; and
a set of negative terminal discharge components, coupled between the negative receiving terminal and said at least one reference terminal, configured to be conductive in response to the voltage level of the negative terminal signal exceeding the predetermined range.

15. The RF circuit of claim 14, wherein said at least one reference terminal comprises a first reference terminal and a second reference terminal, and the ESD protection circuit further comprises a clamp circuit to limit a voltage difference between a voltage level of the first reference terminal and a voltage level of the second reference terminal.

16. The RF circuit of claim 13, wherein the set of ESD components comprise:
a first ESD component, configured to be conductive in response to the voltage level of the positive terminal signal being greater than the voltage level of the negative terminal signal and the voltage difference between the voltage level of the positive terminal signal and the voltage level of the negative terminal signal being greater than the predetermined difference value; and
a second ESD component, configured to be conductive in response to the voltage level of the positive terminal signal being less than the voltage level of the negative terminal signal and the voltage difference between the voltage level of the positive terminal signal and the voltage level of the negative terminal signal being greater than the predetermined difference value.

17. The RF circuit of claim 16, wherein each of the first ESD component and the second ESD component comprises at least one diode.

18. The RF circuit of claim 16, wherein each of the first ESD component and the second ESD component comprises multiple diodes connected in series.
